(19) United States
(12) Patent Application Publication
(10) Pub. No.: US 2015/0030884 A1
(43) Pub. Date: Jan. 29, 2015

(54) METHOD FOR EVALUATING DISPERSION OF MATERIAL FOR LIGHT TO HEAT CONVERSION IN THERMAL TRANSFER FILM AND THERMAL TRANSFER FILM USING THE SAME

(71) Applicant: Samsung SDI Co., Ltd., Yongin-si (KR)

(72) Inventors: Se Hyun Park, Uiwang-si (KR); Kyoung Ku Kang, Uiwang-si (KR); Seong Heun Cho, Uiwang-si (KR); Min Hye Kim, Uiwang-si (KR); Sung Han Kim, Uiwang-si (KR); Si-Kyun Park, Uiwang-si (KR); Eun Su Lee, Uiwang-si (KR); Jung Hyo Lee, Uiwang-si (KR); Jin Hee Choi, Uiwang-si (KR)

(21) Appl. No.: 14/339,418

(22) Filed: Jul. 23, 2014

(30) Foreign Application Priority Data
Jul. 24, 2013 (KR) 10-2013-0087656
May 2, 2014 (KR) 10-2014-0053664

(51) Int. Cl. G01N 21/25; F24J 3/00

(52) U.S. Cl. CPC G01N 21/25; F24J 3/00
USPC 428/688; 702/134

(57) ABSTRACT

A method for evaluating dispersion of a light-to-heat conversion material in a thermal transfer film includes calculating optical densities OD1 and OD2 of the thermal transfer film according to Equations 2 and 3, and calculating a dispersion evaluation value ΔOD according to Equation 1. The thermal transfer film has good dispersion of the light-to-heat conversion material when the dispersion evaluation value ΔOD is 0.1 or less, and the thermal transfer film has poor dispersion of the light-to-heat conversion material when the dispersion evaluation value ΔOD is greater than 0.1.

ΔOD=|OD2−OD1| Equation 1

OD1=−log(T2/T1) Equation 2

OD2=−log(T3/T1) Equation 3

### CROSS-REFERENCE TO RELATED APPLICATIONS

This application claims priority to and the benefit of Korean Patent Application No. 10-2013-0087656, filed in the Korean Intellectual Property Office on Jul. 24, 2013, and Korean Patent Application No. 10-2014-0053664 filed in the Korean Intellectual Property Office on May 2, 2014, the entire contents of both of which are incorporated by reference herein.

### BACKGROUND

1. Field

The present invention relates to a method for evaluating dispersion of a light-to-heat conversion material in a thermal transfer film and a thermal transfer film using the same.

2. Description of the Related Art

A thermal transfer film usually includes a base film and a light-to-heat conversion layer on an upper surface of the base film. The thermal transfer film may further include an intermediate layer on an upper surface of the light-to-heat conversion layer. The thermal transfer film may have an organic luminescent material on the upper surface of the light-to-heat conversion layer or the intermediate layer. When the light-to-heat conversion layer is irradiated with light at an absorption wavelength, a light-to-heat conversion material in the light-to-heat conversion layer absorbs incident light having a specific wavelength and converts at least part of the incident light into heat, whereby the organic luminescent material may be transferred to a pixel defining layer (PDL) on an OLED substrate.

Obtaining good dispersion of the light-to-heat conversion material in the light-to-heat conversion layer may help improve transfer efficiency of the thermal transfer film, while maintaining the uniform appearance of the thermal transfer film (i.e. without spots). Generally, the dispersion of the light-to-heat conversion material in the light-to-heat conversion layer is evaluated based on the images obtained by photographing a cross-section of the light-to-heat conversion layer using transmission electron microscopy (TEM). However, preparation of the samples during this method and TEM measurement take a long time. In addition, since evaluation of the TEM images is usually performed by a user, evaluation results are subjective, have low reliability, and it is difficult to provide specific and accurate numerical evaluation results.

### SUMMARY

One or more aspects of embodiments of the present invention relate to a method for evaluating dispersion of a light-to-heat conversion material in a thermal transfer film. The method includes calculating optical densities OD1 and OD2 of the thermal transfer film according to Equations 2 and 3, respectively, and calculating a dispersion evaluation value (ΔOD) based on the optical densities OD1 and OD2 according to Equation 1. The thermal transfer film has good dispersion of the light-to-heat conversion material when the dispersion evaluation value (ΔOD) is 0.1 or less, and the thermal transfer film has poor dispersion of the light-to-heat conversion material when the dispersion evaluation value (ΔOD) exceeds 0.1.

ΔOD=|OD2−OD1| Equation 1

OD1=−log(T2/T1) Equation 2

OD2=−log(T3/T1) Equation 3

In Equations 1-3, OD1, OD2, T1, T2, and T3 are as defined below.

In one embodiment, the thermal transfer film may include a base layer and a light-to-heat conversion layer on the base layer and including a light-to-heat conversion material. The thermal transfer film may have ΔOD of about 0.011 to about 0.1.

### BRIEF DESCRIPTION OF THE DRAWINGS

FIG. 1 illustrates a diagram representing a UV spectrometer measuring transmittance of a thermal transfer film.

FIG. 2 illustrates a schematic sectional view of a thermal transfer film according to one embodiment of the invention.

FIG. 3 illustrates a schematic sectional view of a thermal transfer film according to another embodiment of the invention.

FIG. 4 to FIG. 9 illustrate TEM images of thermal transfer films prepared in Examples 1 to 4 and Comparative Examples 1 and 2, respectively.

### DETAILED DESCRIPTION OF THE INVENTION

Embodiments of the present invention will be described hereinafter with reference to the accompanying drawings, in which exemplary embodiments of the invention are illustrated. As those skilled in the art would realize, the described embodiments may be modified in various different ways, all without departing from the spirit or scope of the present invention. In the drawings, portions unimportant to the description are omitted for clarity. Same components are denoted by the same reference numerals throughout the specification. As used herein, terms such as “upper” and “lower” are defined with reference to the accompanying drawings. Thus, it will be understood that the term “upper surface” may be used interchangeably with the term “lower surface”, depending on orientation. Expressions such as “at least one of” and “one of,” when preceding a list of elements, modify the entire list of elements and do not modify the individual elements of the list. Further, the use of “may” when describing embodiments of the present invention refers to “one or more embodiments of the present invention.”

In a method for evaluating dispersion of a light-to-heat conversion material in a thermal transfer film (hereinafter, “the dispersion evaluation method”) according to embodiments of the present invention, transmittance of the thermal transfer film is measured to evaluate the dispersion of the light-to-heat conversion material. As used herein, the expression “dispersion of a light-to-heat conversion material” refers to the degree to which the light-to-heat conversion material is dispersed in the light-to-heat conversion layer. In one embodiment, the thermal transfer film may include, for example, a base film and a light-to-heat conversion layer including a light-to-heat conversion material on an upper surface of the base film. In another embodiment, the thermal transfer film may include a base film, a light-to-heat conversion layer including a light-to-heat conversion material on an upper surface of the base film, and an intermediate layer on an upper surface of the light-to-heat conversion layer.

In one embodiment of the invention, the dispersion evaluation method may include calculating optical densities OD1 and OD2 of the thermal transfer film according to Equations 2 and 3, respectively; and calculating a dispersion evaluation value (ΔOD) based on the optical densities OD1 and OD2, according to Equation 1. The thermal transfer film has good dispersion of the light-to-heat conversion material when the dispersion evaluation value (ΔOD) is 0.1 or less, and the thermal transfer film has poor dispersion of the light-to-heat conversion material when the dispersion evaluation value (ΔOD) exceeds 0.1.

ΔOD=|OD2−OD1| Equation 1

In Equation 1, OD1 and OD2 are calculated according to Equations 2 and 3, respectively.

OD1=−log(T2/T1) Equation 2

OD2=−log(T3/T1) Equation 3

In Equations 2 and 3, T1 is the transmittance of the thermal transfer film (in %) measured before placing the thermal transfer film in a transmittance measurement apparatus including a reflective mirror, T2 is the transmittance of the thermal transfer film (in %) measured after placing the thermal transfer film in the transmittance measurement apparatus including the reflective mirror, and T3 is the transmittance of the thermal transfer film (in %) measured after placing the thermal transfer film in the transmittance measurement apparatus without the reflective mirror.

As used herein, the expression “good dispersion” means that the thermal transfer film, in particular, the light-to-heat conversion layer of the thermal transfer film, is substantially free from spots and has uniform distribution of the light-to-heat conversion material. As used herein, the term “substantially” is used as a term of approximation and not a term of degree such that the term “substantially free of spots” means that if the light-to-heat conversion layer has any spots, they are negligible and do not affect the performance of the layer. In some embodiments, the thermal transfer film, in particular the light-to-heat conversion layer of the thermal transfer film, is completely free of spots. For example, the thermal transfer film having “good dispersion” may have a transfer efficiency of about 80% to about 100%.

As used herein, the expression “poor dispersion” means that the thermal transfer film, in particular, the light-to-heat conversion layer of the thermal transfer film, has more than a negligible amount of spots and non-uniform distribution of the light-to-heat conversion material. For example, a thermal transfer film having “poor dispersion” may have a transfer efficiency of less than about 80%.

In one embodiment, the transfer efficiency of the thermal transfer film is obtained by measuring a sample prepared by depositing an organic luminescent material onto the thermal transfer film. The sample is cut to a size of 1 cm×1 cm (length×width) to prepare a specimen for measuring the transfer efficiency. Then, the organic luminescent material of the specimen is transferred to a pixel-defining layer (PDL) on an OLED substrate by laser scanning the entirety of the specimen at a wavelength of 980 nm at 5 A and at a rate of 3 m/sec. The transfer efficiency can then be calculated according to the formula (S2/S1)×100, where S1 is the area of the organic luminescent material deposited onto the specimen before laser scanning, and S2 is the area of the organic luminescent material transferred to the PDL on the OLED substrate after laser scanning.

In one embodiment of the invention, the thermal transfer film may have a ΔOD of about 0.1 or less, as calculated using Equation 1. When ΔOD of the thermal transfer film is within this range, the transfer film has good dispersion of the light-to-heat conversion material in the light-to-heat conversion layer, and may be substantially or completely free from spots. In one embodiment, the thermal transfer film may have a ΔOD of about 0.0001 to about 0.1, of about 0.001 to about 0.1, or of about 0.011 to about 0.1. When the ΔOD of the thermal transfer film is of about 0.011 to about 0.1, the light-to-heat conversion layer may be sufficiently cured (i.e. hardened), and migration of solvent from an adjacent layer to the light-to-heat conversion layer may be prevented or reduced, thus obtaining good transfer efficiency and chemical resistance of the thermal transfer layer.

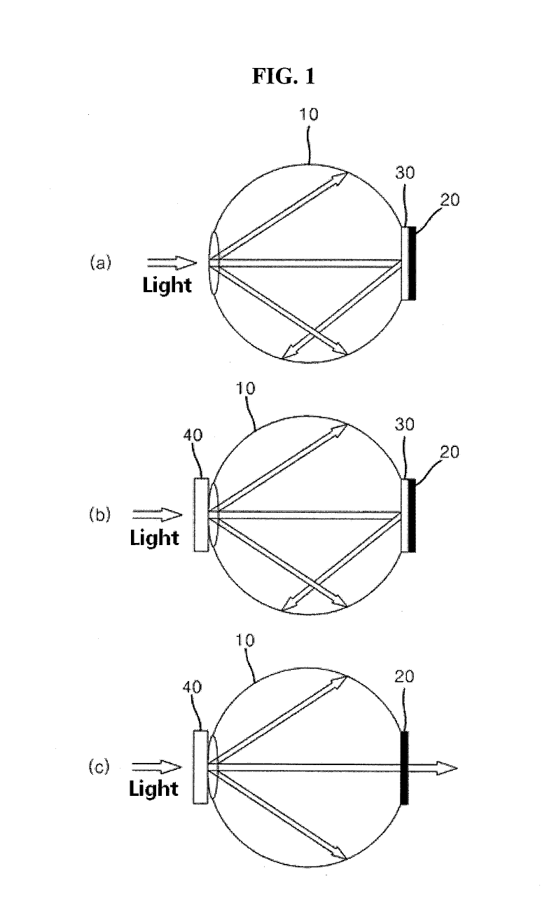

FIG. 1 illustrates a diagram representing a transmittance measurement apparatus (e.g. a UV spectrometer) for measuring transmittance of a thermal transfer film.

Referring to FIG. 1, a transmittance measurement apparatus includes an integrating sphere 10 and a black member 20 on one side of the integrating sphere 10 and including a white reflective mirror 30. When light is irradiated into the integrating sphere 10 (to the side of the integrating sphere 10 opposite the black member 20), and nothing is obstructing the light, the light is either dispersed (or scattered) or travels in a straight line inside the integrating sphere 10, and transmittance T1 is a measurement of the dispersed (or scattered) light components collected together with the light components transmitted in a straight line and reflected by the white reflective mirror 30 inside the integrating sphere 10 (see FIG. 1 (a)). When light is irradiated into the integrating sphere 10, and a thermal transfer film sample 40 is placed in front of the integrating sphere 10 (at the side of the integrating sphere 10 opposite the black member 20), the thermal transfer film sample 40 blocks some of the incident light, and transmittance T2 is a measurement of the resulting dispersed (or scattered) light components together with the light components transmitted in a straight line (see FIG. 1 (b)). Since the thermal transfer film sample 40 does not allow for complete transmittance of light, the resulting optical density is greater than 0. In embodiments where light is irradiated into the integrating sphere 10 through the thermal transfer film sample 40, and the white reflective mirror 30 is removed from the integrating sphere, light transmitted in a straight line may be absorbed by the black member 20, and transmittance T3 is a measurement of only the dispersed (or scattered) light components (see FIG. 1 (c)). Accordingly, transmittance T3 may be low. When transmittance T3 is low, OD2 is higher than OD1, and a higher value of |OD2−OD1| indicates a larger amount of the dispersed (or scattered) light components. In one embodiment, the transmittance measurement apparatus may be a UV/Vis/NIR spectrometer (Model: Lambda 1050 UV/Vis/NIR Spectrophotometer, Perkin Elmer Co., Ltd.).

In one embodiment, all of T1, T2 and T3 may be measured at the same wavelength, for example, at a wavelength of (350−α) nm to (350+α) nm (where α is from 0 to 200), at a wavelength of (1064−β) nm to (1064+β) nm (where β is from 0 to 400), or at a wavelength from 350 nm to 1064 nm.

In one embodiment, each of T1, T2 and T3 may be measured on a thermal transfer film including a 3.0 μm-thick light-to-heat conversion layer formed on a 100 μm-thick polyethylene terephthalate (PET) base film. However, the material and thickness of the base film, and the thickness of the light-to-heat conversion layer are not limited thereto, and the application of the dispersion evaluation method according to embodiments of the present invention is not limited to a certain configuration of the thermal transfer film. In one embodiment, the thermal transfer film is transparent, and T1, T2 and T3 depend only on the light-to-heat conversion material and are not affected by a binder, an initiator, a dispersant, or any other additive included in the formation of the light-to-heat conversion layer.

In one embodiment, the transmittance T1 is measured without placing the thermal transfer film in the transmittance measurement apparatus that includes a reflective mirror, and is provided as a correction factor to correct the transmittance T2 measured after placing the thermal transfer film in the transmittance measurement apparatus. T1 is generally referred to as an overall transmittance and is, for example, a transmittance of 100%, since no sample is blocking the light from entering the integrating sphere. The transmittance T2 is measured by placing the thermal transfer film in the transmittance measurement apparatus that includes the reflective mirror. When light passes through the thermal transfer film, some light components are scattered or refracted by the light-to-heat conversion material in the thermal transfer film, and other light components are transmitted in a straight line. The value of the transmittance T2 is obtained by measuring the light generated from scattered or refracted light components, as well as from the light components transmitted in a straight line and reflected by the white reflective mirror. Generally, the transmittance T2 is measured in the same way as measuring a sample, and when the thermal transfer film is placed in front of the integrating sphere, the sample blocks some of the light irradiated from a UV spectrometer, and transmittance is a measurement of the collected scattered or refracted light components and light components transmitted in a straight line. Since the sample does not allow for 100% transmittance of light, the resulting optical density is greater than 0. The transmittance T3 is measured by placing the thermal transfer film in the transmittance measurement apparatus without the white reflective mirror. In this case, the light components transmitted in a straight line are absorbed instead of being reflected by the white reflective mirror. Accordingly, the transmittance T3 is obtained by measuring only the scattered or refracted light components. In embodiments of the present invention, the white reflective mirror is removed from the integrating sphere, and a light absorption space is provided to the black member to absorb some of the irradiated light. The scattered or refracted light components, having passed through the thermal transfer film, are collected inside the integrating sphere and are used in the calculation of the transmittance, whereas the light components transmitted in a straight line, having passed through the thermal transfer film, are absorbed by the black member and are not collected inside the integrating sphere, thereby resulting in a lower transmittance than T2. When T3 is lower than T2, OD2 is higher than OD1, and a higher value of |OD2-OD1| indicates a larger amount of dispersed (or scattered) light.

The dispersion evaluation method according to embodiments of the present invention may be applied to any thermal transfer film that includes a particulate light-to-heat conversion material such as, for example, a solid light-to-heat conversion material capable of scattering or refracting light. In one embodiment, the light-to-heat conversion material may include particles having an average particle diameter of about 20 nm to about 300 nm, and may include, for example and without limitation, inorganic pigments such as carbon black, tungsten oxide, or the like, which have an average particle diameter of about 20 nm to about 300 nm.

In embodiments where the light-to-heat conversion material is carbon black, when the thermal transfer film has a ΔOD of about 0.1 or less at a wavelength of 1064 nm, carbon black may have good dispersion in the light-to-heat conversion layer. Conversely, when the thermal transfer film has a ΔOD of greater than about 0.1 at a wavelength of 1064 nm, carbon black may have poor dispersion in the light-to-heat conversion layer.

In one embodiment, the light-to-heat conversion material may be carbon black, and the thermal transfer film may have a ΔOD of about 0.011 to about 0.1 at a wavelength of 1064 nm. Within this range, carbon black may be well dispersed in the light-to-heat conversion layer, and the thermal transfer film including the light-to-heat conversion layer may have good chemical resistance. In one embodiment, the carbon black may have an average particle diameter of about 100 nm to about 300 nm, as measured using a dynamic light scattering (DLS) particle size analyzer or the like, but the average particle diameter of carbon black is not limited thereto.

In another embodiment, the light-to-heat conversion material may be tungsten oxide, and the thermal transfer film may have a ΔOD of about 0.1 or less at a wavelength of 350 nm. Within this range, tungsten oxide may have good dispersion in the light-to-heat conversion layer. Conversely, when the thermal transfer film has a ΔOD of greater than about 0.1, tungsten oxide may have poor dispersion in the light-to-heat conversion layer.

In embodiments where the light-to-heat conversion material is tungsten oxide, the thermal transfer film may have a ΔOD of about 0.011 to about 0.1 at a wavelength of 350 nm. Within this range, tungsten oxide may be well dispersed in the light-to-heat conversion layer, and the thermal transfer film including the light-to-heat conversion layer may have good chemical resistance. In one embodiment, the tungsten oxide may have an average particle diameter of about 20 nm to about 200 nm, as measured using the dynamic light scattering (DLS) particle size analyzer or the like, but the average particle diameter of tungsten oxide is not limited thereto.

In one embodiment, the dispersion evaluation method according to embodiments of the invention may be utilized as described above for a thermal transfer film including a mixture of inorganic pigments including at least two of carbon black and tungsten oxide as the light-to-heat conversion material.

In the dispersion evaluation method according to some embodiments, dispersion of the light-to-heat conversion material may be evaluated by only measuring the transmittance of the thermal transfer film. In addition, the dispersion evaluation method does not require a long sample preparation process, other than cutting the thermal transfer film, thereby allowing for a relatively fast evaluation. Furthermore, the dispersion evaluation method may secure objective evaluation criteria based on digitized ΔOD values, thereby improving evaluation reliability.

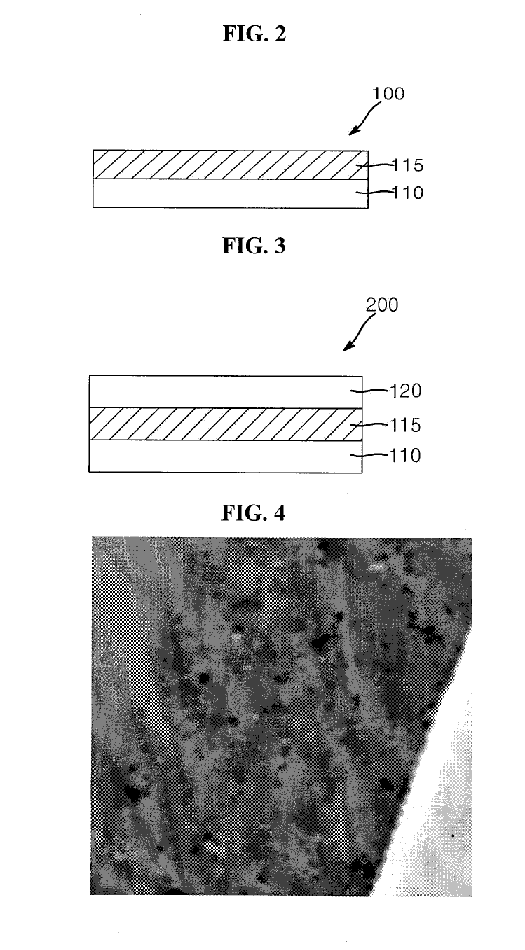

Hereinafter, a thermal transfer film according to one embodiment of the invention will be described with reference to FIG. 2. FIG. 2 is a schematic sectional view of a thermal transfer film according to one embodiment of the invention.

Referring to FIG. 2, a thermal transfer film 100 according to one embodiment of the invention may include a base film 110 and a light-to-heat conversion layer 115 on an upper surface of the base film 110. The thermal transfer film 100 may have a ΔOD of about 0.1 or less, as measured by the dispersion evaluation method described above. When the thermal transfer layer has a ΔOD within this range, the light-to-heat conversion material in the light-to-heat conversion layer may exhibit good dispersion. In one embodiment, the ΔOD may range from about 0.011 to about 0.1. Within this range, the light-to-heat conversion material may exhibit good dispersion, thereby providing a thermal transfer film that is substantially or completely free from spots and that exhibits good transfer efficiency while maintaining sufficient chemical resistance.

The base film 110 may be a transparent polymer film, but is not limited thereto. Non-limiting examples the transparent polymer film include a polyester film, a polyacrylic film, a polyepoxy film, a polyethylene film, a polypropylene film and/or a polystyrene film. In one embodiment, the base film may be a polyester film such as, for example, a polyethylene terephthalate film or a polyethylene naphthalate film. In some embodiments, the base film may have a thickness of about 10 μm to about 500 μm, and in some embodiments of about 40 μm to about 100 μm. When the base film has a thickness within these ranges, the thermal transfer film including the base film may have advantageous properties.

In one embodiment, the light-to-heat conversion layer 115 may include a binder, a light-to-heat conversion material, an initiator, and a dispersant.

The binder may include photocurable resins including UV curable resins and the like, polyfunctional monomers, and/or mono-functional monomers. Non-limiting examples of the photocurable resins may include (meth)acrylate resins, phenol resins, polyvinyl butyral resins, polyvinyl acetate resins, polyvinyl acetal resins, polyvinylidene chloride resins, polyacrylate resins, cellulose ester resins, cellulose ether resins, nitrocellulose resins, polycarbonate resins, poly(alkyl(meth)acrylate) resins, epoxy (meth)acrylate resins, epoxy resins, urethane resins, ester resins, ether resins, alkyd resins, spiroacetal resins, polybutadiene resins, and polythiol polyene resins. As used herein, the term “(meth)acrylate” refers to acrylates and methacrylates.

When the binder includes polyfunctional monomer, the polyfunctional monomer may include one of two or more functional (meth)acrylate monomers. In one embodiment, the polyfunctional monomer provides a certain degree of hardness to the light-to-heat conversion layer. In one embodiment, the polyfunctional monomer may be a monomer containing one or more (meth)acrylate groups, for example, two to six (meth)acrylate groups. Non-limiting examples of the polyfunctional (meth)acrylate monomer may include at least one of trimethylolpropane di(meth)acrylate, trimethylolpropane tri(meth)acrylate, pentaerythritol di(meth)acrylate, pentaerythritol tri(meth)acrylate, pentaerythritol tetra(meth)acrylate, dipentaerythritol penta(meth)acrylate, dipentaerythritol hexa(meth)acrylate, di(trimethylolpropane)tetra(meth)acrylate, tris(2-hydroxyethyl)isocyanurate tri(meth)acrylate, hexanediol di(meth)acrylate, and cyclodecandimethanol di(meth)acrylate.

When the binder includes a mono-functional monomer, at least one mono-functional (meth)acrylate monomer may be used. Non-limiting examples of the mono-functional (meth)acrylate monomer may include at least one of polypropylene glycol mono(meth)acrylate, polyethyleneglycol mono(meth)acrylate, butoxyethyl(meth)acrylate, octadecyl(meth)acrylate, lauryl(meth)acrylate, dodecyl(meth)acrylate, undecyl(meth)acrylate, isodecyl(meth)acrylate, decyl(meth)acrylate, nonyl(meth)acrylate, isooctyl(meth)acrylate, octyl(meth)acrylate, heptyl(meth)acrylate, hexyl(meth)acrylate, isoamyl(meth)acrylate, pentyl, (meth)acrylate, t-butyl (meth)acrylate, amyl(meth)acrylate, butyl (meth)acrylate, isopropyl(meth)acrylate, propyl(meth)acrylate, ethyl (meth)acrylate, and methyl (meth)acrylate.

In one embodiment, the binder may be present in an amount of about 20% by weight (wt %) to about 85 wt %, of about 60 wt % to about 85 wt %, of about 35 wt % to about 80 wt %, or of about 35 wt % to about 70 wt %, in terms of solids content in the composition for the light-to-heat conversion layer. When the binder is included within these ranges, it is possible to form a matrix for a stable light-to-heat conversion layer.

The light-to-heat conversion material is a material capable of absorbing light in a range of wavelengths (for example, about 350 nm to about 1064 nm) and converting the light into heat. In one embodiment, the light-to-heat conversion material is in particle form having an average particle size of about 20 nm to about 300 nm, but the average particle size of the light-to-heat conversion material is not limited thereto. In one embodiment, the light-to-heat conversion material allows for scattering or refraction of light by dispersion of the particles, and may comprise an inorganic pigment including at least one of carbon black and tungsten oxide. As the particle size of the light-to-heat conversion material decreases, short wavelengths such as, for example, 350 nm may be more advantageous for scattering or refraction of light than long wavelengths such as, for example, 1,064 nm.

In one embodiment, the light-to-heat conversion material may be present in an amount of about 10 wt % to about 70 wt %, of about 10 wt % to about 60 wt %, of about 10 wt % to about 50 wt %, or of about 10 wt % to about 30 wt %, in terms of solids content in the composition for the light-to-heat conversion layer. When the light-to-heat conversion material is included within these ranges, it is possible to form a matrix for a stable light-to-heat conversion layer.

In some embodiments, the thermal transfer film may include carbon black as the light-to-heat conversion material, and may have a ΔOD of 0.1 or less, and in some embodiments from about 0.011 to about 0.1, at a wavelength of 1064 nm. Within these ranges, the thermal transfer film may exhibit good dispersion of carbon black and good chemical resistance.

In other embodiments, the thermal transfer film may include tungsten oxide as the light-to-heat conversion material, and may have a ΔOD of about 0.1 or less, and in some embodiments from about 0.011 to about 0.1, at a wavelength of 350 nm. Within these ranges, the thermal transfer film may exhibit good dispersion of tungsten oxide and good chemical resistance.

Any suitable photopolymerization initiator and/or heat-curable initiator may be utilized as the initiator, so long as the initiator can increase the hardness of the thermal transfer film by curing the binder. Non-limiting examples of the initiator may include a benzophenone compound such as 1-hydroxycyclohexyl phenyl ketone.

In one embodiment, the initiator may be present in an amount of about 0.1 wt % to about 10 wt % or of about 1 wt % to about 4 wt %, in terms of solids content in the composition for the light-to-heat conversion layer. When the initiator is included within these ranges, the initiator allows for sufficient formation of the light-to-heat conversion layer, while preventing or reducing the deterioration in optical density due to unreacted initiator.

Any suitable dispersant may be utilized as the dispersant. Non-limiting examples of the dispersant may include acrylate dispersants, ether dispersants, ester dispersants, alkyl dispersants, silicon dispersants, or the like.

In one embodiment, the dispersant may be present in an amount of about 0.01 wt % to about 2.5 wt %, of 0.1 wt % to 2.5 wt %, of 0.01 wt % to 0.5 wt %, or of about 0.1 wt % to about 0.5 wt %, in terms of solids content in the composition for the light-to-heat conversion layer. When the dispersant is included within these ranges, the dispersant may improve heat transfer rate while also improving the dispersion of the light-to-heat conversion material.

In one embodiment, the composition for the light-to-heat conversion layer may include about 20 wt % to about 85 wt % of the binder, about 10 wt % to about 70 wt % of the light-to-heat conversion material, about 0.1 wt % to about 10 wt % of the initiator, and about 0.01 wt % to about 2.5 wt % of the dispersant, in terms of solids content. In another embodiment, the composition for the light-to-heat conversion layer may include about 60 wt % to about 85 wt % of the binder, about 10 wt % to about 30 wt % of carbon black, about 0.1 wt % to about 10 wt % of the initiator, and about 0.1 wt % to about 2.5 wt % of the dispersant, in terms of solids content. In another embodiment, the composition for the light-to-heat conversion layer may include about 20 wt % to about 50 wt % of the binder, about 40 wt % to about 70 wt % of tungsten oxide, about 0.1 wt % to about 10 wt % of the initiator, and about 0.01 wt % to about 0.2 wt % of the dispersant, in terms of solids content. Within these content ranges, the composition for the light-to-heat conversion layer has good dispersion of the light-to-heat conversion material, chemical resistance, and transfer efficiency.

The composition for the light-to-heat conversion layer may further include a solvent to aid in coating the composition on the base film. The solvent may include, for example, propylene glycol monomethyl ether acetate and/or ketones such as methylethylketone and methylisobutylketone, but is not limited thereto.

In one embodiment, the light-to-heat conversion layer may be formed by coating the composition for the light-to-heat conversion layer (which includes the binder, the light-to-heat conversion material, the initiator and the dispersant) onto the base film, followed by thermal curing and/or photocuring. Thermal curing may be carried out at a temperature of about 60° C. to about 100° C., and photocuring may be performed by UV irradiation at a dose of about 10 mJ/cm² to about 3000 mJ/cm², but the conditions for thermal curing and/or photocuring are not limited thereto.

The light-to-heat conversion layer may have a thickness of greater than about 1 μm and less than about 10 μm, and in some embodiments from about 1.5 μm to about 5 μm. When the light-to-heat conversion layer has a thickness within these ranges, it is possible to achieve efficient heat transfer.

Hereinafter, a thermal transfer film according to another embodiment of the invention will be described with reference to FIG. 3. FIG. 3 is a sectional view of a thermal transfer film according to another embodiment of the invention.

Referring to FIG. 3, a thermal transfer film 200 includes a base film 110, a light-to-heat conversion layer 115 on an upper surface of the base film 110, and an intermediate layer 120 on an upper surface of the light-to-heat conversion layer 115. The thermal transfer film 200 may have a ΔOD of about 0.1 or less, and in some embodiments of about 0.011 to about 0.1, as measured by the dispersion evaluation method described above. When the thermal transfer film has a ΔOD within these ranges, the light-to-heat conversion material included in the light-to-heat conversion layer may exhibit good dispersion, thereby providing a thermal transfer film that is substantially or completely free from spots and exhibits good transfer efficiency. Other than including the intermediate layer, the thermal transfer film according to this embodiment is substantially the same as the thermal transfer film according to the above-described embodiment.

Non-limiting examples of the intermediate layer may include a polymer film, a metal layer, an inorganic layer (for example, a layer formed by sol-gel deposition or vapor deposition of an inorganic oxide such as silica, titania or other metal oxides), and an organic/inorganic composite layer. The organic material included in the composite layer may be a thermosetting and/or thermoplastic material. In one embodiment, the intermediate layer may include a photocurable resin, a polyfunctional monomer, an initiator, and a solvent. In one embodiment, the composition for the intermediate layer may include about 70 wt % to about 90 wt % of the photocurable resin, about 5 wt % to about 20 wt % of the polyfunctional monomer, and about 0.1 wt % to about 10 wt % of the initiator, in terms of solids content. When the composition of the intermediate layer is within these ranges, the thermal transfer film may have improved chemical resistance.

In one embodiment, the intermediate layer may have a transmittance of about 98.0% at a wavelength of (350−α) nm to (350+α) nm (where α is from 0 to 200), or at a wavelength of (1064−β) nm to (1064+β) nm (where β is from 0 to 400), or at a wavelength of 350 nm to 1064 nm. In one embodiment, the intermediate layer may have a transmittance of about 98.0% to about 99.9%. When the transmittance of the intermediate layer is within these ranges, the intermediate layer does not affect the OD of the thermal transfer layer as calculated using Equation 1.

Hereinafter, embodiments will be described with reference to certain examples. However, these examples are provided for illustration only and are not to be construed in any way as limiting the scope of the present disclosure.

### Preparative Example 1

A solvent mixture was prepared by mixing 70.15 g of methylethylketone and 39.05 g of propylene glycol monomethyl ether acetate. 25 g of polymethyl methacrylate (Elvacite® 4059, Lucite Int.) and 40 g of an epoxy acrylate binder as UV curable resins, 17 g of a tri-functional acrylate monomer (SR351, Sartomer Co., Inc.) as a polyfunctional monomer, and 3 g of Irgacure® 184 (BASF) as a photopolymerization initiator were added to the solvent mixture, followed by stirring the resulting binder mixture for 30 minutes. To the binder mixture, 15 g of carbon black (average particle size 190 nm) and 0.21 g of a dispersant (DISPERBYK 2001) were added, followed by stirring the resulting mixture for 30 minutes, thereby preparing a composition for a light-to-heat conversion layer.

### Preparative Example 2

A solvent mixture was prepared by mixing 70.15 g of methylethylketone and 39.05 g of propylene glycol monomethyl ether acetate. 25 g of polymethyl methacrylate (Elvacite® 4059, Lucite Int.) and 40 g of an epoxy acrylate binder as UV curable resins, 17 g of a tri-functional acrylate monomer (SR351, Sartomer Co., Inc.) as a polyfunctional monomer, and 3 g of Irgacure® 369 (BASF) as a photopolymerization initiator were added to the solvent mixture, followed by stirring the resulting binder mixture for 30 minutes. Then, 15 g of carbon black (average particle size 170 nm) and 0.15 g of a dispersant (DISPERBYK 140) were added to the binder mixture, followed by stirring the resulting mixture for 30 minutes, thereby preparing a composition for a light-to-heat conversion layer.

### Preparative Example 3

A solvent mixture was prepared by mixing 70.15 g of methylethylketone and 39.05 g of propylene glycol monomethyl ether acetate. 25 g of polymethyl methacrylate (Elvacite® 4059, Lucite International Inc.) and 40 g of an epoxy acrylate binder as UV curable resins, 17 g of a tri-functional acrylate monomer (SR351, Sartomer Co., Inc.) as a polyfunctional monomer, and 3 g of Irgacure® 369 (BASF) as a photopolymerization initiator were added to the solvent mixture, followed by stirring the resulting binder mixture for 30 minutes. Then, 15 g of carbon black (average particle size 140 nm) and 0.4 g of a dispersant (DISPERBYK 163) were added to the binder mixture, followed by stirring the resulting mixture for 30 minutes, thereby preparing a composition for a light-to-heat conversion layer.

### Preparative Example 4

A solvent mixture was prepared by mixing 70.15 g of methylethylketone and 39.05 g of propylene glycol monomethyl ether acetate. 25 g of polymethyl methacrylate (Elvacite® 4059, Lucite International Inc.) and 40 g of an epoxy acrylate binder as UV curable resins, 17 g of a tri-functional acrylate monomer (SR454, Sartomer Co., Inc.) as a polyfunctional monomer, and 3 g of Irgacure® 369 (BASF) as a photopolymerization initiator were added to the solvent mixture, followed by stirring the resulting binder mixture for 30 minutes. Then, 15 g of carbon black (average particle size 170 nm) was added to the binder mixture, followed by stirring the resulting mixture for 30 minutes, thereby preparing a composition for a light-to-heat conversion layer.

### Preparative Example 5

A solvent mixture was prepared by mixing 70.15 g of methylethylketone and 39.05 g of propylene glycol monomethyl ether acetate. 25 g of polymethyl methacrylate (Elvacite® 4026, Lucite International Inc.) and 40 g of an epoxy acrylate binder as UV curable resins, 17 g of a tri-functional acrylate monomer (SR351, Sartomer Co., Inc.) as a polyfunctional monomer, and 3 g of Irgacure® 369 (BASF) as a photopolymerization initiator were added to the solvent mixture, followed by stirring the resulting binder mixture for 30 minutes. Then, 15 g of carbon black (average particle size 190 nm) was added to the binder mixture, followed by stirring the resulting mixture for 30 minutes, thereby preparing a composition for a light-to-heat conversion layer.

### Preparative Example 6

A solvent mixture was prepared by mixing 70.15 g of methylethylketone and 39.05 g of propylene glycol monomethyl ether acetate. 25 g of polymethyl methacrylate (Elvacite® 2550, Lucite International Inc.) and 40 g of an epoxy acrylate binder as UV curable resins, 17 g of a tri-functional acrylate monomer (SR351, Sartomer Co., Inc.) as a polyfunctional monomer, and 3 g of Irgacure® 369 (BASF) as a photopolymerization initiator were added to the solvent mixture, followed by stirring the resulting binder mixture for 30 minutes. Then, 15 g of carbon black (average particle size 190 nm) and 3 g of DISPERBYK-2155 were added to the binder mixture, followed by stirring the resulting mixture for 30 minutes, thereby preparing a composition for a light-to-heat conversion layer.

### Preparative Example 7

A solvent mixture was prepared by mixing 80.15 g of methylethylketone and 61.05 g of propylene glycol monomethyl ether acetate. 10 g of polymethyl methacrylate (Elvacite® 2016, Lucite International Inc.) and 30 g of an epoxy acrylate binder as UV curable resins, 10 g of a tri-functional acrylate monomer (SR351, Sartomer Co., Inc.) as a polyfunctional monomer, and 2 g of Irgacure® 369 (BASF) as a photopolymerization initiator were added to the solvent mixture, followed by stirring the resulting binder mixture for 30 minutes. Then, 70 g of tungsten oxide (average particle size 40 nm) and 0.12 g of DISPERBYK-2000 were added to the binder mixture, followed by stirring the resulting mixture for 30 minutes, thereby preparing a composition for a light-to-heat conversion layer.

### Preparative Example 8

A solvent mixture was prepared by mixing 80.15 g of methylethylketone and 61.05 g of propylene glycol monomethyl ether acetate. 10 g of polymethyl methacrylate (Elvacite® 2927, Lucite International Inc.) and 30 g of an epoxy acrylate binder as UV curable resins, 10 g of a tri-functional acrylate monomer (SR351, Sartomer Co., Inc.) as a polyfunctional monomer, and 2 g of Irgacure® 369 (BASF) as a photopolymerization initiator were added to the solvent mixture, followed by stirring the resulting binder mixture for 30 minutes. Then, 70 g of tungsten oxide (average particle size 40 nm) was added to the binder mixture, followed by stirring the resulting mixture for 30 minutes, thereby preparing a composition for a light-to-heat conversion layer.

### Preparative Example 9

A solvent mixture was prepared by mixing 80.15 g of methylethylketone and 61.05 g of propylene glycol monomethyl ether acetate. 10 g of polymethyl methacrylate (Elvacite® 2927, Lucite International Inc.) and 30 g of an epoxy acrylate binder as UV curable resins, 10 g of a tri-functional acrylate monomer (SR351, Sartomer Co., Inc.) as a polyfunctional monomer, and 2 g of Irgacure® 369 (BASF) as a photopolymerization initiator were added to the solvent mixture, followed by stirring the resulting binder mixture for 30 minutes. Then, 70 g of tungsten oxide (average particle size 30 nm) and 0.4 g of DISPERBYK-2152 were added to the binder mixture, followed by stirring the resulting mixture for 30 minutes, thereby preparing a composition for a light-to-heat conversion layer.

### Preparative Example 10

16 parts by weight of polymethyl methacrylate, 10 parts by weight of epoxy acrylate, 4 parts by weight of tri-functional acrylate monomer, 0.5 parts by weight of Irgacure® 369, and 55 parts by weight of methylethylketone were mixed to prepare a composition for an intermediate layer.

### Example 1

The composition for a light-to-heat conversion layer of Preparative Example 1 was coated onto a PET film (A4100, Toyobo, 100 μm) by bar coating and dried at 80° C. for 2 minutes. The composition was then cured at a UV dose of 300 mJ/cm² under a nitrogen atmosphere, thereby preparing a thermal transfer film having an optical density (OD) of 1.2 and including a 3.0 μm-thick light-to-heat conversion layer. Then, the transmittance T1 (in %) was measured at a wavelength of 1064 nm using a UV/Vis/NIR Spectrophotometer Lambda 1050 (Perkin Elmer Co., Ltd.), without placing the thermal transfer film in a holder placed at a portion of an integrating sphere through which light enters. The transmittance T1 was generally 100%. Then, the thermal transfer film was placed in the holder at the portion of the integrating sphere through which light enters, and the transmittance T2 (in %) was measured at a wavelength of 1064 nm using the UV/Vis/NIR Spectrophotometer Lambda 1050 (Perkin Elmer Co., Ltd.). The transmittance T2 can range from 0% to 100%.

Then, the outer cover of the integrating sphere having a black interior in the UV/Vis/NIR Spectrophotometer Lambda 1050 (Perkin Elmer Co., Ltd.) was open and a white plate (i.e. white reflective mirror) used for reflecting light passing through the thermal transfer film was removed from the integrating sphere. Then, the outer cover of the integrating sphere was closed, the thermal transfer film was placed at a portion of the integrating sphere through which light enters, and the transmittance T3 (in %) was measured at a wavelength of 1064 nm. The transmittance T3 can be in the range of 0% to 100%. Optical densities OD1 and OD2 were calculated using Equations 2 and 3, respectively, and dispersion was calculated using Equation 1.

### Example 2

A thermal transfer film was prepared as in Example 1 except that the composition for a light-to-heat conversion layer of Preparative Example 2 was used instead of the composition of Preparative Example 1. Dispersion was calculated as in Example 1.

### Example 3

A thermal transfer film was prepared as in Example 1 except that the composition for a light-to-heat conversion layer of Preparative Example 3 was used instead of the composition of Preparative Example 1. Dispersion was calculated as in Example 1.

### Example 4

A thermal transfer film was prepared as in Example 1 except that the composition for a light-to-heat conversion layer of Preparative Example 6 was used instead of the composition of Preparative Example 1. Dispersion was calculated as in Example 1.

### Example 5

The composition for a light-to-heat conversion layer of Preparative Example 7 was coated onto a PET film (A4100, Toyobo, 100 μm) by bar coating and dried at 80° C. for 2 minutes, thereby forming a coating layer including a light-to-heat conversion layer on the base layer. Then, the composition for an intermediate layer of Preparative Example 10 was coated onto the coating layer and dried in the same manner as above, followed by curing at 300 mJ/cm², thereby preparing a thermal transfer film in which the 3 μm-thick light-to-heat conversion layer and the intermediate layer were sequentially formed on the PET film. Dispersion was calculated as in Example 1 except that transmittance was measured at a wavelength of 350 nm instead of 1064 nm, using the UV/Vis/NIR Spectrophotometer Lambda 1050 (Perkin Elmer Co., Ltd.).

### Example 6

A thermal transfer film was prepared as in Example 5 except that the composition for a light-to-heat conversion layer of Preparative Example 6 was used instead of the composition of Preparative Example 7. Dispersion was calculated as in Example 1.

### Example 7

A thermal transfer film was prepared as in Example 5 except that the composition for a light-to-heat conversion layer of Preparative Example 9 was used instead of the composition of Preparative Example 7. Dispersion was calculated as in Example 1 except that transmittance was measured at a wavelength of 350 nm instead of 1064 nm, using the UV/Vis/NIR Spectrophotometer Lambda 1050 (Perkin Elmer Co., Ltd.).

### Comparative Example 1

A thermal transfer film was prepared as in Example 1 except that the composition for a light-to-heat conversion layer of Preparative Example 4 was used instead of the composition of Preparative Example 1. Dispersion was calculated as in Example 1.

### Comparative Example 2

A thermal transfer film was prepared as in Example 1 except that the composition for a light-to-heat conversion layer of Preparative Example 5 was used instead of the composition of Preparative Example 1. Dispersion was calculated as in Example 1.

### Comparative Example 3

A thermal transfer film was prepared as in Example 5 except that the composition for a light-to-heat conversion layer of Preparative Example 8 was used instead of the composition of Preparative Example 7. Dispersion was calculated as in Example 1 except that transmittance was measured at a wavelength of 350 nm instead of 1064 nm, using the UV/Vis/NIR Spectrophotometer Lambda 1050 (Perkin Elmer Co., Ltd.).

TEM images of the thermal transfer films prepared in Examples 1 through 4 and Comparative Examples 1 through 2 were evaluated using a Tecnai G2 F30 S-TWIN FE-TEM (manufactured by FEI), and sampling was performed at room temperature using a diamond knife and a PowerTome Ultramicrotome PT-XL (manufactured by RMC). Properties of each of the thermal transfer films were evaluated, and the results are shown in Tables 1 and 2.

### Property Evaluation

(1) Spots: Each of the thermal transfer films prepared in Examples 1 through 4 and Comparative Examples 1 through 2 was cut to a sample having a size of 50 cm×50 cm (length×width). A backside of the thermal transfer film sample was observed under white light. If no spots were observed, the sample was marked as “good”, and if spots were observed, the sample was marked as “poor”.

(2) Dispersion: OD of 0.1 or less was marked as “good” and ΔOD of greater than 0.1 was marked as “poor”. ΔOD of less than 0.011 was marked as “excellent”.

(3) Transfer efficiency: Samples were prepared by depositing an organic luminescent material on each of the thermal transfer films and cutting the specimen to a size of 1 cm×1 cm (length×width), followed by laser scanning the specimen at a wavelength of 980 nm at 5 A (A=ampere), and at a rate of 3 m/sec. Measurements of transfer efficiency of each sample were obtained by calculating a percent ratio of an area (S2) of the organic luminescent material transferred to a pixel-defining layer (PDL) of an OLED substrate after laser scanning to an area (S1) of the organic luminescent material deposited on the specimen before laser scanning.

(4) Chemical resistance (measured using methylethylketone (MEK) rubbing test): Each of the thermal transfer films was cut to a sample having a size of 15 cm×15 cm (length×width) and 10 ml of methylethylketone was dropped onto a central section of each sample, followed by mopping the sample with cotton fibers after 40 seconds. If no delamination of the light-to-heat conversion layer was observed, the sample was marked as “good”, and even if slight delamination of the light-to-heat conversion layer was observed, the sample was marked as “poor”.

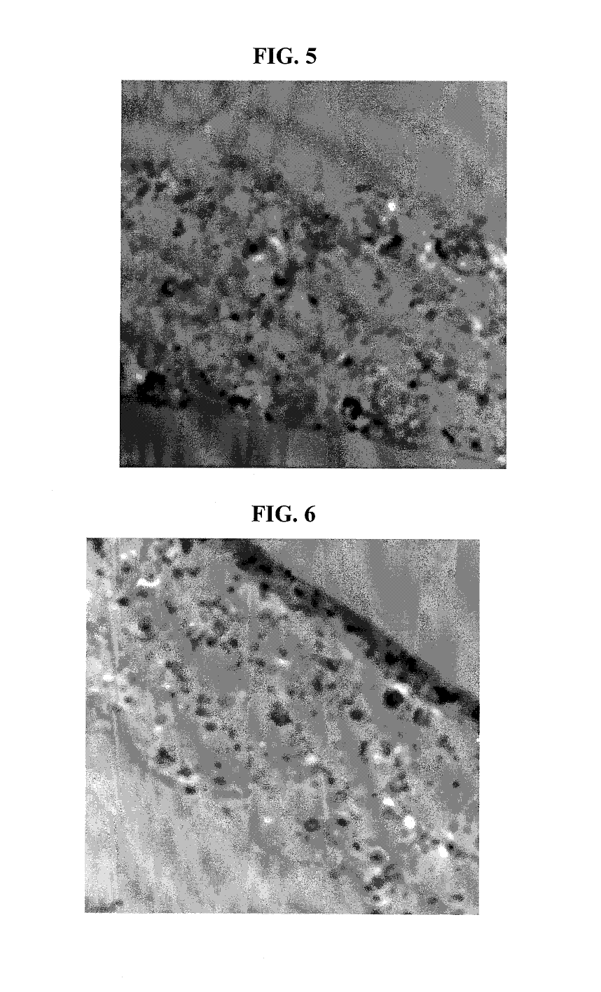

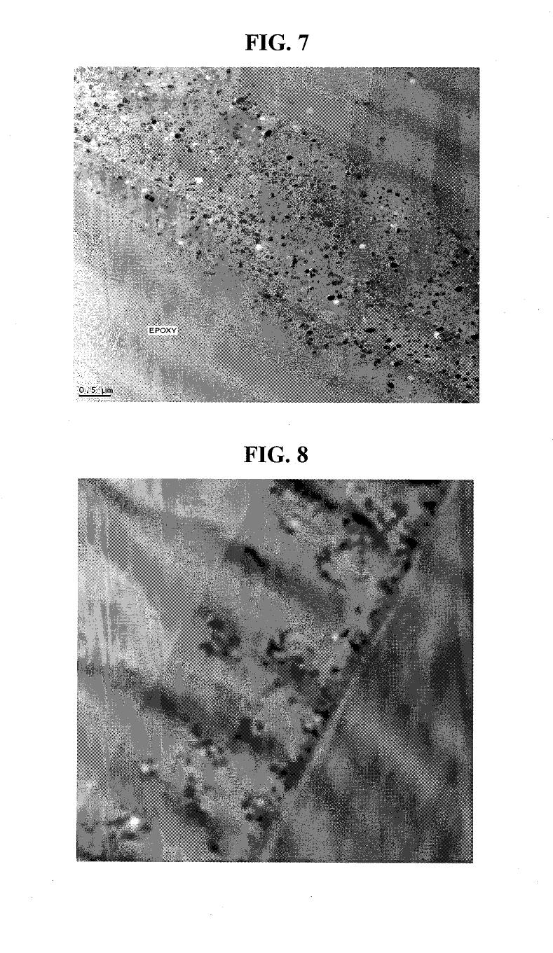

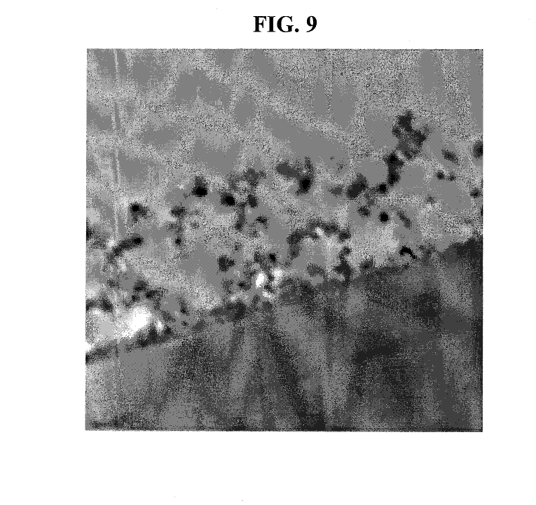

TABLE 1

| | | | | | Comparative | Comparative |
|---|---|---|---|---|---|---|
| | Example 1 | Example 2 | Example 3 | Example 4 | Example 1 | Example 2 |
| Presence of | Present | Present | Present | Present | Not present | Not present |
| dispersant in | | | | | | |
| light-to-heat | | | | | | |
| conversion layer | | | | | | |
| OD1 | 1.1890 | 1.1606 | 1.2216 | 1.2611 | 1.2033 | 1.1502 |
| OD2 | 1.2083 | 1.1800 | 1.2373 | 1.2720 | 1.3245 | 1.2838 |
| Dispersion | 0.0193 | 0.0194 | 0.0157 | 0.0109 | 0.1212 | 0.1336 |
| evaluation value | | | | | | |
| (ΔOD) | | | | | | |
| TEM image | FIG. 4 | FIG. 5 | FIG. 6 | FIG. 7 | FIG. 8 | FIG. 9 |
| Dispersion | good | good | good | excellent | poor | poor |
| Spot | good | good | good | good | poor | poor |
| Transfer | 95 | 94 | 97 | 94 | 79 | 77 |
| efficiency (%) | | | | | | |

Based on the results shown in Table 1, and without being bound by any particular theory, it is believed that the method for evaluating dispersion of a light-to-heat conversion material according to the present embodiments provides reliable evaluation results, as illustrated by a comparison of the TEM images and the ΔOD values. Indeed, evaluation of dispersion based solely on the TEM images of the thermal transfer films confirmed good dispersion of the thermal transfer films of Examples 1 to 4 including the dispersant (shown in FIG. 4 to FIG. 7), and poor dispersion of thermal transfer films of Comparative Examples 1 and 2 not including the dispersant (shown in FIG. 8 and FIG. 9). The thermal transfer films prepared in Examples 1 to 4 had good dispersion and high transfer efficiency, whereas the thermal transfer films prepared in Comparative Examples 1 to 2 had poor dispersion and low transfer efficiency. The method according to embodiments of the present invention can be used to evaluate dispersion of the light-to-heat conversion material based only on measurement of transmittance, and these results coincide with the presence or absence of spots on the thermal transfer layer and the degree of transfer efficiency.

TABLE 2

| | | | | Comparative |
|---|---|---|---|---|
| | Example 5 | Example 6 | Example 7 | Example 3 |
| Presence of dispersant | Present | Present | Present | Not Present |
| in light-to-heat con- | | | | |
| version layer | | | | |
| Presence of intermedi- | Present | Present | Present | Present |
| ate layer | | | | |
| OD1 | 1.0163 | 1.2610 | 1.0836 | 0.9950 |
| OD2 | 1.0810 | 1.2712 | 1.0944 | 1.4032 |
| Dispersion evaluation | 0.0647 | 0.0102 | 0.0108 | 0.4082 |
| value (ΔOD) | | | | |
| Dispersion | good | excellent | excellent | poor |
| Spot | good | good | good | poor |
| Transfer efficiency | 94 | 68 | 66 | 78 |
| (%) | | | | |
| Chemical resistance | good | poor | poor | good |

As shown in Table 2, the thermal transfer film prepared in Example 5 had good dispersion and exhibited good chemical resistance. Thus, when the thermal transfer film of Example 5 was evaluated to have good dispersion, it also exhibited stable properties in terms of spot generation, transfer efficiency, and chemical resistance. Although the thermal transfer films of Examples 6 and 7 had excellent dispersion, the light-to-heat conversion layer of these films was not sufficiently dried and/or cured in formation of the light-to-heat conversion layer, and the solvent included in the composition for the intermediate layer partially migrated into the light-to-heat conversion layer, thereby deteriorating transfer efficiency due to low chemical resistance. In addition, the thermal transfer film of Comparative Example 3 had a ΔOD of greater than about 0.1, and thus exhibited poor dispersion.

Although some embodiments have been described above, it should be understood that the invention is not limited to these embodiments and can cover various modifications, changes, alterations, and equivalent embodiments within the spirit and scope of the appended claims and equivalents thereof. Therefore, it should be understood that the above embodiments are provided for illustration only and should not be construed in any way as limiting the invention.

What is claimed is:

1. A method for evaluating dispersion of a light-to-heat conversion material in a thermal transfer film, the method comprising:
calculating optical densities OD1 and OD2 of the thermal transfer film according to Equations 2 and 3, respectively; and
calculating a dispersion evaluation value ΔOD according to Equation 1
ΔOD=|OD2−OD1| Equation 1
OD1=−log(T2/T1) Equation 2
OD2=−log(T3/T1) Equation 3
wherein T1 is transmittance of the thermal transfer film before placing the thermal transfer film in a transmittance measurement apparatus including a reflective mirror, T2 is transmittance of the thermal transfer film after placing the thermal transfer film in the transmittance measurement apparatus including the reflective mirror, and T3 is transmittance of the thermal transfer film after placing the thermal transfer film in the transmittance measurement apparatus without the reflective mirror, and
wherein the thermal transfer film is determined to have satisfactory dispersion of the light-to-heat conversion material when the dispersion evaluation value ΔOD is 0.1 or less, and the thermal transfer film is determined to have unsatisfactory dispersion of the light-to-heat conversion material when the dispersion evaluation value ΔOD is greater than 0.1.

2. The method according to claim 1, wherein T1, T2 and T3 are each measured at a wavelength of (350−α) nm to (350+α) nm, wherein α is 0 to 200, or at a wavelength of (1064−β) nm to (1064+β) nm, wherein β is 0 to 400.

3. The method according to claim 1, wherein the light-to-heat conversion material comprises an inorganic pigment including at least one of carbon black and tungsten oxide.

4. The method according to claim 3, wherein the carbon black has an average particle diameter of about 100 nm to about 300 nm.

5. The method according to claim 3, wherein the tungsten oxide has an average particle diameter of about 20 nm to about 200 nm.

6. The method according to claim 1, wherein, when the ΔOD of the thermal transfer film is about 0.011 to about 0.1, the thermal transfer film is determined to have satisfactory dispersion of the light-to-heat conversion material.

7. A thermal transfer film comprising a base layer and a light-to-heat conversion layer on the base layer and comprising carbon black,
wherein the dispersion of the thermal transfer film is evaluated according to the method of claim 1, and the ΔOD of the thermal transfer film as calculated according to Equation 1 is about 0.011 to about 0.1.

8. The thermal transfer film according to claim 7, further comprising an intermediate layer on an upper surface of the light-to-heat conversion layer.
